(19) United States
(12) Patent Application Publication
(10) Pub. No.: US 2026/0301248 A1
(43) Pub. Date: Oct. 1, 2026

(54) END-TO-END TRACKING AND PREDICTION SYSTEM AND METHOD FOR HIGH DEFINITION (HD) VECTORIZED MAP CONSTRUCTION

(71) Applicant: Honda Motor Co., Ltd., Tokyo (JP)

(72) Inventors: Zhihao Zheng, Bethlehem, PA (US); Bo Lang, Bethlehem, PA (US); Nirav Bhagavanji Savaliya, San Jose, CA (US); Jinglun Feng, San Jose, CA (US); Zheng-Hang Yeh, Milpitas, CA (US)

(73) Assignee: Honda Motor Co., Ltd., Tokyo (JP)

(21) Appl. No.: 19/341,320

(22) Filed: Sep. 26, 2025

Related U.S. Application Data
(60) Provisional application No. 63/776,596, filed on Mar. 24, 2025.

(51) Int. Cl. G06T 11/20; G06V 20/56

(52) U.S. Cl. CPC G06T 11/23; G06V 20/56

(57) ABSTRACT

An end-to-end tracking and prediction system for high definition (HD) vectorized map construction is provided. The system may have a bird's-eye-view (BEV) encoder processing multi-view images at each frame extracting perception features from the multi-view images. The system may have a semantic-aware query generator producing semantic-aware queries from the perception features and generating a rasterized map through multi-layer decoding. The system may have a map decoder processing the perception features and the semantic-aware queries together to produce mapping elements.

### RELATED APPLICATIONS

This patent application is related to U.S. Provisional Application No. 63/776,596 filed Mar. 24, 2025, entitled “BIRD'S-EYE VIEW (BEV) HIGH DEFINITION (HD) MAP RECONSTRUCTION”, in the names of the same inventors and which is incorporated herein by reference in its entirety. The present patent application claims the benefit under 35 U.S.C § 119 (e) of the aforementioned provisional application.

### BACKGROUND

High-definition (HD) maps may be needed for map-based autonomous driving, providing rich semantic and geometric context of the environment. Traditionally, HD maps may be constructed through point cloud-based simultaneous localization and mapping (SLAM) systems, using either camera-light detection and ranging (LiDAR) fusion or LiDAR-only approaches followed by manual annotation of semantic elements such as lane boundaries, dividers, crosswalks, and directionality. While accurate, this pipeline may be labor-intensive, expensive, and difficult to scale. Recently, deep learning-based methods have emerged as a scalable alternative, which may enable online vectorized HD map construction from camera-only or camera LiDAR fusion inputs. These approaches may offer a cost-effective solution for building large-scale city maps and, due to their online nature, may support deployment in unseen environments and facilitate dynamic map change detection.

Early methods may have approached vectorized HD map construction either as a per-frame BEV rasterization task or as a detection transformer (DETR)-style point set prediction and aggregation problem. BEV rasterization methods may typically require post-processing to extract vectorized map elements. Other trends may leverage the DETR-based detection paradigm to directly predict single-frame vectorized map components by decoding learnable queries from the BEV features in parallel, as may be shown in FIG. 1A. However, due to the elongated and structured nature of road map elements, deformable DETR based models may struggle to capture the semantic and geometric information of map instances in complex scenes. To address this, later methods may incorporate geometric priors, leveraging the fact that map elements may follow well-defined shapes. While this may improve structural consistency, these methods may still suffer from limited performance, primarily because these methods may operate on individual frames without propagating temporal information from previous predictions. Recent methods, as may be shown in FIG. 1B, may try to maintain separate memory modules to ensure temporal consistency in predictions. Other methods may propose to use streaming fusion to maintain a single latent memory whereas Map Tracker may use separate BEV Raster and Vector latent memories.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, an end-to-end tracking and prediction system for high definition (HD) vectorized map construction is provided. The system may have a bird's-eye-view (BEV) encoder processing multi-view images at each frame extracting perception features from the multi-view images. The system may have a semantic-aware query generator producing semantic-aware queries from the perception features and generating a rasterized map through multi-layer decoding. The system may have a map decoder processing the perception features and the semantic-aware queries together to produce mapping elements.

According to an embodiment of the disclosure, an end-to-end tracking and prediction system for HD vectorized map construction is provided. The system may have a BEV encoder processing multi-view images at each frame to extract perspective-view features and BEV features. The system may have a semantic-aware query generator extracting semantic-aware queries from the BEV features using mask-aware attention and generating a rasterized map with BEV segmentation mask through multi-layer decoding. The system may have a map decoder processing the perspective-view features and BEV features and the semantic-aware queries together to produce coordinates, roadway markings, and certainty scores. The system may have a filtering device filtering output detected queries of the map decoder as positive using a detection threshold based on the certainty scores.

According to an embodiment of the disclosure, a method of forming an end-to-end tracking and prediction system for HD vectorized map construction is provided. The method may process multi-view images at each frame to extract perspective-view features and BEV features. The method may extract semantic-aware queries from the BEV features using mask-aware attention and generate a rasterized map with BEV segmentation mask through multi-layer decoding. The method may process the perspective-view features and BEV features and the semantic-aware queries together to produce coordinates, roadway markings, and certainty scores through a map decoder. The method may filter output detected queries of the map decoder as positive using a detection threshold based on the certainty scores. The method may store a predicted rasterized map for each tracked instance in a map memory. The method may sample corresponding positions on the extract perspective-view features and BEV features from the map memory establishing a geometric prior for progressing track queries in a new frame and progressing propagation of track queries across temporal sequences.

### BRIEF DESCRIPTION OF THE DRAWINGS

FIG. 1A shows an exemplary system for predicting single-frame vectorized map components by decoding learnable queries from the BEV features in parallel, in accordance with an embodiment of the disclosure;

FIG. 1B shows an exemplary system for HD map construction having separate memory modules in accordance with an embodiment of the disclosure;

FIG. 1C shows an exemplary vectorized HD map construction framework for temporal consistency in predictions in accordance with an embodiment of the disclosure;

FIG. 2 shows a block diagram of an exemplary vectorized HD map system in accordance with an embodiment of the disclosure; and

FIG. 3 depicts an exemplary chart showing a comparison between the vectorized HD map system of FIG. 3 and other systems in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

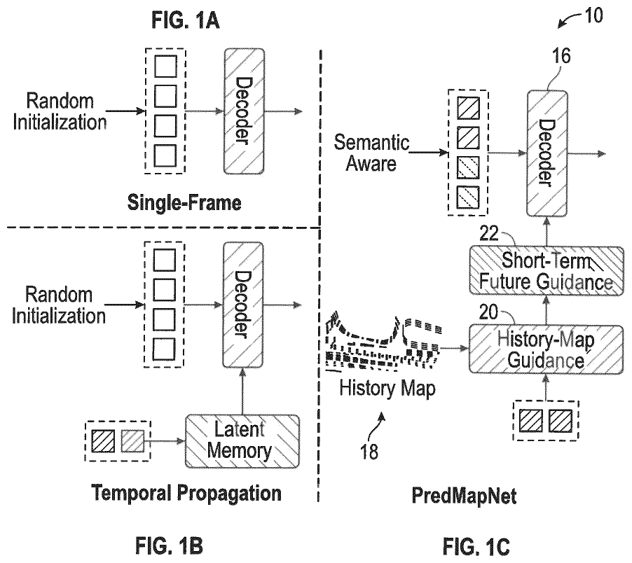

The present system and method provide an enhancing vectorized HD map construction framework, which may be referred to as PredMapNet. As illustrated in FIG. 1C, a semantic-aware query generator (SAQG), may be used which may utilize class-agnostic BEV segmentation masks to guide query refinement. Unlike random initialization, this approach may leverage global semantic context to produce context-aligned queries, which may improve query quality and training convergence. Second, historical rasterized map features via a history-map guidance (HMG) module may be incorporated, enabling smoother and more continuous HD map construction and better utilization of temporal priors. Finally, a short-term future guidance (STFG) module may be used that may explicitly predicts the near-future positions of map instances. By injecting motion priors, STFG may improve the temporal stability of tracked queries and may ensure more coherent instance predictions across consecutive frames. The present system and method may achieve new state-of-the-art results as may be shown on two representative benchmarks of online vectorized HD map construction, validating the effectiveness of the proposed modules.

In summary, the main features of the present system and method may be as follows:
An end-to-end framework for consistent online HD map construction which may rely on a SAQG to capture semantic information for map instances, which may enhance spatial alignment and semantic awareness.
A unified framework for temporal reasoning that may incorporate both historical and future guidance. Specifically, a history-map guidance module may be formed to integrate fine-grained historical priors from history maps, and a STFG module to forecast instance-level motion, together optimizing the temporal propagation process and enhancing the stability and consistency of map construction.

The task of online vectorized HD map construction has received increasing attention in recent years. HDMapNet may have pioneered this line of work by lifting surround-view image features into the BEV space and extracting a rasterized BEV representation, which later may be post-processed to obtain vectorized map elements. In contrast, VectorMapNet and MapTR may formulate the task as a DETR-style point set prediction problem. VectorMapNet may first detect map elements and then autoregressively generates polylines for each instance. MapTR may introduce a permutation-invariant formulation by designing a hierarchical query embedding scheme, performing bipartite matching at both instance and point levels to predict all vertices simultaneously. MapTRv2 may build upon MapTR by decoupling self-attention operations to reduce memory usage and computational complexity.

More recent geometry-aware approaches may improve upon prior methods by incorporating inductive biases from map element geometries. BeMapNet may represent elements as piecewise B'ezier curves, while GeMap may learn geometry-aware features that may be invariant to translation and rotation. PivotNet may follow the set prediction paradigm and may model each map element using a dynamic set of pivotal points. HIMap may introduce a novel hybrid representation, enabling joint learning from both rasterized and vectorized formats through a proposed point-element interaction mechanism.

In visual object tracking, the query tracking paradigm may have gained significant popularity in recent years, with methods such as TrackFormer, TransTrack, and MOTR. These methods may be further extended in MeMOT and MeMOTR by introducing memory modules which may ensure long-range temporal consistency.

In BEV perception, there may be two fundamental strategies for memory fusion: stacking and streaming. Stacking-based approaches, such as BEVDet4D and BEVFormer v2, may process multiple historical frames in a single pass. While effective, this design may incur substantial memory and computation costs that may scale with the number of input frames, which may limit scalability and restrict temporal modeling to short-term horizons. In contrast, the streaming fusion strategy may process frames sequentially, propagating memory features from previous frames. This may enable longer temporal associations with reduced memory usage and lower latency.

StreamMapNet may extend the single-frame vectorized HD map construction paradigm to a temporally consistent mapping framework. It may leverage a streaming fusion strategy and may introduce a multi-point attention mechanism to handle irregular and elongated map elements. SQD-MapNet may build upon StreamMapNet by incorporating temporal curve denoising, inspired by DN-DETR. Map Tracker may enhance memory modules by stacking two types of memory buffers, rasterized and vectorized BEV memories, and may adopt a query propagation paradigm for tracking. PrevPredMap may introduce a lightweight approach to improve temporal consistency by reusing previous predictions as memory for future frames.

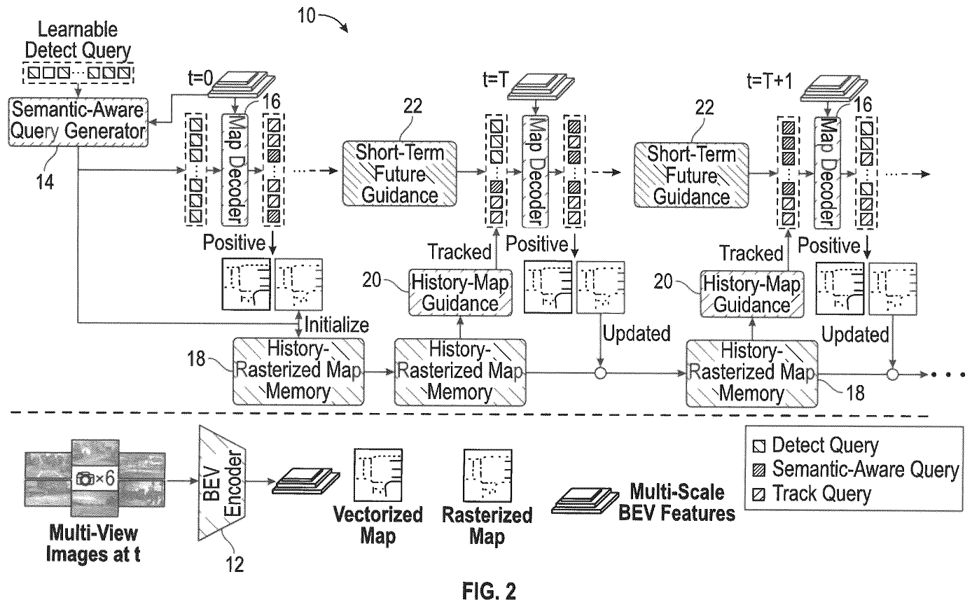

The present overall architecture may follow a query-based tracking and prediction paradigm for both rasterized and vectorized map construction, as illustrated in FIG. 2. As may be shown in FIG. 2, the framework 10 may operate in a frame-by-frame manner. At each frame, multi-view images may be processed by the BEV encoder 12 to extract both perspective-view (PV) features Fpv and bird's-eye view (BEV) features F_{bev}, which may provide strong spatial priors for perception. Semantic-aware query generator 14 may extract semantic-aware queries from BEV features using the mask-aware attention and may generate rasterized map (BEV segmentation masks) through multi-layer decoding. Then, the perception features together with the semantic-aware detect queries Q∈R^{Nq×C} may interact through the map decoder 16 to produce the coordinates P∈R^{Nq×Np×2}, categories C∈R^{Ng×3} (pedestrian crossing, road boundary, lane divider) and scores S∈R^{Nq}. Here, Nq may denote the number of detected queries, Nₚ may represent the number of points of a map instance. After the map decoder 16, the output detected queries may be filtered to be positive using a detection threshold T_{det}. Meanwhile the propagated track queries which may be initialized with the corresponding detect queries tracked in the previous frame may be filtered via a tracking threshold T_{track}. These positive N_{track} queries Q_{track} may be propagated to the next frame as new track queries. Queries with confidence scores below the thresholds may be treated as disappeared instances and discarded as negative queries.

To propagate temporal information, a history rasterized map memory 18 may be maintained that may store previous predicted rasterized map for each tracked instance. Furthermore, the HMG module 20 may utilize the history map to sample corresponding positions on perception features extracted by the encoder, which may establish a strong geometric prior for optimizing track queries in the new frame and explicitly optimizing the propagation of track queries across temporal sequences. In addition, the short-term future guidance (STFG) module 22 may take the history trajectories of the positive N_{track} queries Q_{track} as inputs and may predict short-term future positions of each query. In the next new frame, these predicted future locations may serve as hints for the map decoder 16 to focus on the area of perception features with high possibility. The history prior and future guidance may provide a good initialization to track queries, which may be better aware of the perception features for accurate map instance localization.

Recent approaches may treat map construction as a set prediction problems where each query may be responsible for generating one map component. These learnable query-based decoding frameworks may directly predict vectorized map elements by decoding queries from BEV features in parallel. However, these queries may be initialized randomly and may lack explicit alignment with the scene context, limiting their capacity to jointly encode semantic and geometric cues of map instances in complex environments. To overcome this limitation, the semantic-aware query generator 14 may be introduced that may capture global semantic context to guide query generation more effectively.

A semantic-aware query generation strategy based on the mask transformer architecture introduced in Mask2Former may be adopted. Specifically, a set of learnable detect queries may be initialized and progressively refined through L layers of a transformer decoder. At each decoding layer l, the queries may interact with the multi-scale BEV feature maps F_{bev} and may be guided by the segmentation masks

$${M}_{l - 1} = {\{ {M}_{q , l - 1} \}}_{q = 1}^{{N}_{q}}$$

produced in the (l−1)-th layer. The corresponding semantic-aware (SA) detection queries

$${Q}_{l - 1}^{S A} = {\{ {Q}_{q , l - 1}^{S A} \}}_{q = 1}^{{N}_{q}}$$

may then be updated to capture both spatial and semantic context for subsequent decoding:

$${{M}^{\text{?}}}_{l - 1} = \{ \begin{matrix}0 , & if {M}_{l - 1} > {τ}_{L} \\ - ∞ & otherwise\end{matrix} \qquad ( 1 )$$

$${Q}_{l} = {Q}_{l - 1}^{SA} {W}^{Q} , {K}_{l} = {F}_{\text{?}}^{\text{?}} {W}^{K} \text{?} {V}_{l} = {F}_{\text{?}}^{\text{?}} {W}^{V} \qquad ( 2 )$$

$${Q}_{l}^{SA} = softmax ( {{M}^{\text{?}}}_{l - 1} + {Q}_{l} {K}_{l}^{T} ) {V}_{l} + {Q}_{l - 1}^{SA} \qquad ( 3 )$$

$$\text{?} \text{indicates text missing or illegible when filed}$$

where T_{L} may denote a threshold, N_{q} may denote the number of the semantic-aware detection queries, and W^{Q}, W^{K}, W^{V} may be learnable weight matrices. Finally, the instance-level BEV segmentation masks M_{L} may be obtained by applying dot product between BEV feature F_{bev} and the semantic-aware detection queries

$${Q}_{L}^{S A}$$

along the channel axis. The BEV segmentation masks may further be used to update the instance-level history maps.

The history rasterized map memory 18 may be created to store the previous predicted instance-level segmentation masks. For each tracked instance generated during online prediction, its instance-level segmentation mask may be maintained to store its trajectory and temporal features. During the propagation stage, each track query may be uniquely associated with a corresponding map instance and its history map, thereby enforcing a one-to-one relationship. At the beginning of frame t, the history rasterized map memory may be defined as

$${M}^{t} = warp \{ {M}_{i}^{t} \vert i = 1 , 2 , … , {N}_{track}^{t - 1} \} ,$$

where each

$${M}_{i}^{t} ∈ {R}^{{H}_{x} W}$$

may indicate the BEV segmentation mask of the i-th instance tracked in the previous frame t−1, Hand W may be the height and width of the BEV feature respectively.

To incorporate the current rasterized map outputs at timestamp t, the memory may be updated as follows: for the j-th instance, if it is identified as a newly born instance (i.e., no corresponding tracking index is found, and its confidence score

$${S}_{j}^{t}$$

exceeds the detect threshold T_{det}), its predicted BEV segmentation mask

$${M}_{j}^{t}$$

may be scaled by

$${S}_{j}^{t}$$

to initialize its history map. If the instance has been tracked (i.e., some tracking index is associated, and

$${S}_{j}^{t}$$

exceeds the tracking threshold T_{track}), the corresponding historical map

$${M}_{i}^{t - 1}$$

may be retrieved based on its tracking index i and warped to t using known ego motions for alignment:

$${\hat{M}}_{i}^{t} = ( {M}_{i}^{t - 1} , {T}^{t} ) \qquad ( 4 )$$

where T^{l} may denote a standard 4×4 transformation matrix, Warp(⋅) may be the alignment function. In this case, the updated rasterized map memory may be represented as:

$${M}_{\text{?}}^{t} = \{ \begin{matrix}{M}_{j}^{t} \cdot {S}_{j}^{t} , & New born \\ max ( λ \cdot {M}_{\text{?}}^{t - 1} , {M}_{j}^{t} \cdot {S}_{j}^{t} ) , & Tracked\end{matrix} \qquad ( 5 )$$

$$\text{?} \text{indicates text missing or illegible when filed}$$

If the prediction confidence of a track query falls below the tracking threshold T_{track}, it may indicate that the corresponding instance has either disappeared or failed to be reliably tracked in the current frame. As a result, the associated track query and its history map

$${M}_{r}^{t - 1}$$

may be removed from the map memory. To this end, the memory may be dynamically optimized, and each map instance may follow the process of initialization, tracking, and updating to enable temporal propagation.

To address the limitations of implicit temporal propagation in capturing detailed feature transformations during motion, the HMG module 20 may be designed to integrate historical rasterized map information into track queries, which may enhance temporal prior utilization and perceptual consistency. The HMG module 20 may first sample instance features from the BEV feature spaces, guided by the corresponding semantic regions. Due to the variable number of sampled features per instance, padding may be applied to normalize feature lengths and padding mask may be applied to ensure that each track query focuses on its corresponding positions during feature aggregation. The sampled instance-level features may then be fused into the corresponding track queries via cross-attention, which may enable more informed and temporally consistent predictions.

The historical rasterized mask stored in the memory may provide both semantic category and spatial location information. To enhance the semantic representation of track queries, previous track categories may be encoded into a class embedding CE E R^{N}^{_{track}}^{×C}. The class embedding may be fused with the track query to provide category priors as:

$${Q}_{track} = {Q}_{track} + CE \qquad ( 6 )$$

The history map may also serve as a fine-grained spatial prior with temporal decay. To extract reliable regions, a valid pixel mask Mᵥₐₗ may be calculated by filtering pixels in history map M via a threshold Tₘₐₚ. To enhance the spatial awareness of BEV features in 3D space, a sinusoidal position embedding PE_{bev}∈R^{H×W×C} may be introduced. The valid pixel mask Mᵥₐₗ may then be used to guide feature extraction from F_{bev}, resulting in position-aware BEV features:

$${F}_{sampled \_ ev} = {M}_{val} \cdot ( {F}_{b e v} + P {E}_{b e v} ) \qquad ( 7 )$$

where H, W may be the resolutions of the BEV features.

Subsequently, with the instance-specific BEV features extracted, the track queries may be enriched using these contextual cues. Specifically, the track queries together with the sampled BEV features F_{sampled_bev} may be fed into a cross attention layer CA(⋅), which may yield the final initialized track queries for the current frame:

$${Q}_{track} = CA ( {Q}_{t rack} , {F}_{sampled \_ bev} ) \qquad ( 8 )$$

Finally, historical rasterized maps may be incorporated as priors to guide the track queries, which may eliminate the need for redundant auxiliary supervision and may mitigate errors introduced by implicit temporal propagation. The present HMG module 20 may leverage instance-level rasterized maps to enhance global geometric consistency and further keep temporally consistency.

In current frameworks like MapTracker, the propagation of tracked queries may often be reactive, i.e., relying only on previous-frame information and cross-attention with the current BEV features. This may lead to unstable predictions under rapid scene changes, occlusions, or sensor noise. To address these challenges, STFG module 22 may be used that may explicitly predict and incorporate short-term future locations of map instances. By providing the model with explicit motion priors, the STFG module 22 may enhance the temporal stability of track queries, enabling more reliable and coherent map instance detection across consecutive frames.

Trajectory Prediction. Inspired by VIP3D, the current framework 10 may be extended to a query-based prediction, for predicting the short term future of tracked map instances. Specifically, for each tracked map query, a history of decoded poly-lines over the past n frames may be maintained:

$$\{ {P}_{i}^{t - n + 1} , {P}_{i}^{t - n + 2} , … , {P}_{i}^{t} \} where {P}_{i}^{{t}^{′}} ∈ {R}^{{N}_{p} x 2} .$$

These sequential polylines may be stacked into a temporal sequence and fed into a lightweight trajectory encoder (e.g. gated recurrent unit (GRU)) to capture motion patterns and geometric evolution. The encoder may predict a point-wise offset field Δ∈∈R^{N}^{ₚ}^{×2} representing its short-term deformation toward the next frame. The future polyline may be estimated as:

$${\hat{P}}_{i}^{t + 1} = {P}_{i}^{t} + Δ {P}_{i}^{t \to t + 1} \qquad ( 9 )$$

By modeling temporal dynamics explicitly, the STFG module 22 may produce structured future predictions that may maintain geometric consistency and enhance alignment across frames.

Fusion with Track Queries. Once the short-term future polyline

$${\hat{P}}_{i}^{t + 1} ∈ {R}^{{N}_{p} x 2}$$

of i-th map instance is predicted, each predicted point coordinate to a high-dimensional space may be encoded using a learnable positional embedding function φ:

$$P {E}_{i}^{future} = \frac{1}{{N}_{P}} {\sum }_{1}^{{N}_{P}} ϕ ( {\hat{P}}_{i , k}^{t + 1} ) , k = 1 , … {N}_{P} \qquad ( 10 )$$

here, the point-wise embeddings may be aggregated to form a compact representation of the entire polyline and adopt mean pooling for simplicity and efficiency. This global future embedding

$$P {E}_{i}^{future} ∈ {R}^{C}$$

may capture the predicted spatial distribution and overall structure of the instance in the next frame. It may act as a temporal positional prior for guiding the query update.

To inject the predicted short-term future into the next frame's query propagation, the current track query embedding

$${Q}_{track}^{t}$$

may be fused with its corresponding future embedding

$$P {E}_{i}^{future} .$$

This operation may yield the updated track query

$${Q}_{track}^{t + 1}$$

to be used in the transformer decoder in timestamp t+1, which may represents as follows:

$${Q}_{track}^{t + 1} = Linear ( [ {Q}_{track}^{t} , {PE}_{i}^{future} ] ) \qquad ( 11 )$$

where [⋅] may denote concatenation.

With this, the track query may be enabled to carry both semantic context from previous frames and spatial priors derived from predicted motion. As a result, the decoder in the next frame may be better guided to attend to spatial regions that are both semantically relevant and temporally consistent, avoiding implausible detection and inaccurate global map construction.

The present framework 10 may build on MapTracker, which may serve as the primary baseline. It may keep BEV loss (LBEV) and VEC loss (Ltrack) functions consistent with MapTracker. In addition, similar to Mask2Former, it may supervise the BEV segmentation masks produced by the semantic-aware query generator 14 using the binary cross-entropy mask loss and the dice loss with λ_{dice}=2 and λ_{bce}=1.

$${L}_{s e g} = {λ}_{dice} \cdot {L}_{dice} + {λ}_{b c e} \cdot {L}_{b c e} \qquad ( 12 )$$

To train the short-term future guidance module, a trajectory prediction loss may be used that may align predicted future polylines \hat{P}^{t+1} with ground-truth locations

$${P}_{gt}^{t + 1} :$$

$${L}_{pred} = C D ( {\hat{P}}^{t + 1} , {P}_{gt}^{t + 1} ) \qquad ( 13 )$$

where CD is Chamfer Distance.

Finally, following MapTRv2, an auxiliary depth prediction loss Ldepth may be used that may improves 3D spatial reasoning in the image backbone. The overall loss may be defined as the weighted sum of the above losses:

$${L}_{total} = {L}_{BEV} + {L}_{t r ack} + {L}_{s e g} + {L}_{p red} + {L}_{depth} \qquad ( 14 )$$

Experimental results of the framework 10 may be provided below. The results of the framework 10 may be provided and compared with SOTA methods using two widely-used autonomous driving datasets: nuScenes, Argoverse2. All ablation studies may be based on nuScenes dataset.

The present framework 10 may build on MapTracker, which may serve as the primary baseline. Training on the nuScenes dataset may have been conducted on 4 NVIDIA RTX A100 GPUs for 72 epochs across three stages (18, 6, and 48 epochs). Similarly, the Argoverse2 dataset may have been trained on for 35 epochs (12, 3, and 20 epochs) to align with MapTracker. The hyperparameters may have been configured as N_{q}=100, Nₚ=20, C=512, τ_{det}=0.4, τ_{track}=0.5, τₘₐₚ=0.5, λ=0.95.

Datasets. The framework 10 may be evaluated on two popular autonomous driving datasets: nuScenes and Argoverse2. The nuScenes dataset may contain 1,000 scenes, each spanning 20 seconds, with data from six synchronized RGB cameras and detailed pose information. The Argoverse2 dataset may include 1,000 sequences with high-resolution images from seven ring cameras, two stereo cameras, LiDAR point clouds, and map-aligned 6-DoF pose data. Experiments may be conducted on both the old and new dataset splits for comprehensive evaluation.

Evaluation Metrics. Following previous work, two evaluation metrics may be adopted: Average Precision (AP) based on Chamfer distance proposed and AP based on rasterization. The Chamfer distance metric may be primarily utilized, using thresholds of 0.5, 1.0, and 1.5 meters for mean AP (mAP). For rasterization-based mean AP (mAPt), intersection over union may be measured for each map instance, with thresholds set {0.50, 0.55, . . . , 0.75} for pedestrian crossings and {0.25, 0.30, . . . , 0.50} for line-shaped elements. In addition, consistency-aware metric (C-mAP) may be employed.

The comparisons with state-of-the-art methods on the nuScenes dataset old split may be shown in Table 1. The present framework 10 may demonstrate superior performance at 24 epochs, achieving 73.2 mAP, outperforming Mask2Map, which achieves 71.6 mAP, by +1.6 mAP. In addition, the present framework 10 may achieve 64.3 C-mAP, outperforming Mask2Map by +8.5 C-mAP. In the 72-epoch setting, the present framework 10 achieved 76.9 mAP, 69.7 C-mAP respectively. Furthermore, recent methods like Mask2Map and MGMap may use single-frame frameworks with limited temporal modeling, while the present framework 10 outperforms them in all metrics. Notably, by removing transformation loss supervision of Motion MLP, thw framework 10 may achieve about 20% faster training than MapTracker. During inference, the present framework 10 may run at 10.1 FPS, slightly slower than MapTracker's 10.9 FPS due to feature sampling overhead, which could be optimized with parallel acceleration in practical applications. In summary, the framework 10 may improve performance and remains practical for real-time autonomous driving applications. Table 3 may evaluate the performance of the framework 10 based on a rasterization-based metric. Notably, the present framework 10 may achieve a remarkable performance gain of 27.6 mAPt over MapTRv2 and may outperform Mask2Map by 9.6 mAPt.

TABLE 1
Comparison with SOTA methods on the nuScenes validation set.

| Method | Epoch | AP_{ped} | AP_{divider} | AP_{boundary} | mAP † | C-mAP † | FPS |
|---|---|---|---|---|---|---|---|
| PivotNet [9] | 24 | 56.2 | 56.5 | 60.1 | 57.6 | — | — |
| MapTRv2 [18] | 24 | 59.8 | 62.4 | 62.4 | 61.5 | 41.7 | 14.1 |
| HRMapNet [41] | 24 | 65.8 | 67.4 | 68.5 | 67.3 | 49.2 | 10.3 |
| StreamMapNet [37] | 24 | 61.9 | 66.3 | 62.1 | 63.4 | 38.4 | 13.1 |
| MGMap [21] | 24 | 61.8 | 65.0 | 67.5 | 64.8 | 43.5 | 13.4 |
| Mask2Map [8] | 24 | 70.6 | 71.3 | 72.9 | 71.6 | 55.8 | 9.2 |
| PredMapNet (Ours) | 24 | 74.1 | 72.8 | 72.6 | 73.2 | 64.3 | 10.1 |
| HRMapNet [41] | 110 | 72.0 | 72.9 | 75.8 | 73.6 | 61.4 | 10.3 |
| MapTRv2 [18] | 110 | 69.3 | 68.5 | 70.3 | 69.5 | 50.5 | 14.1 |
| Mask2Map [8] | 110 | 73.6 | 73.1 | 77.3 | 74.6 | 60.3 | 9.2 |
| MapTracker [5] | 72 | 80.0 | 74.1 | 74.1 | 76.1 | 69.1 | 10.9 |
| PredMapNet (Ours) | 72 | 75.2 | 76.5 | 79.0 | 76.9 | 69.7 | 10.1 |

The results on the Argoverse2 dataset, as may be shown in Table 2, further validate the effectiveness of the framework 10. The framework 10 may achieve a notable mAP improvement of +8.7 over HRMapNet and +9.6 over MapTRv2. Additionally, the framework 10 may surpass MapTracker with +0.5 mAP, +0.8 C-mAP at 35 epochs, demonstrating that the framework 10 may achieve consistent performance across different scenarios.

TABLE 2
Comparison with SOTA methods on the Argoverse2 validation set.

| Method | Epoch | AP_{ped} | AP_{divider} | AP_{boundary} | mAP † | C-mAP † |
|---|---|---|---|---|---|---|
| MapTRv2 [18] | 24 | 62.9 | 72.1 | 67.1 | 67.4 | — |
| HRMapNet [41] | 30 | 65.1 | 71.4 | 68.6 | 68.3 | — |
| StreamMapNet [37] | 30 | 62.0 | 59.5 | 63.0 | 61.5 | — |
| Mask2Map [8] | 24 | 68.1 | 72.7 | 73.7 | 71.5 | — |
| MapTracker [5] | 35 | 76.9 | 79.9 | 73.6 | 76.8 | 68.3 |
| PredMapNet (Ours) | 35 | 77.2 | 80.3 | 74.5 | 77.3 | 69.1 |

TABLE 3
Comparison of SOTA methods on nuScenes validation set with
rasterization-based metric. The “★” indicates results
reproduced using public codes.

| Method | Epoch | ${AP}_{ped}^{†}$ | ${AP}_{divider}^{†}$ | ${AP}_{boundary}^{†}$ | mAP† |
|---|---|---|---|---|---|
| MapTR [17] | 24 | 32.4 | 23.5 | 17.1 | 24.3 |
| MapTRv2* [18] | 24 | 49.9 | 34.7 | 25.7 | 36.7 |
| Mask2Map [8] | 24 | 62.9 | 52.3 | 48.9 | 54.7 |
| PredMapNet (Ours) | 24 | 69.3 | 60.1 | 63.5 | 64.3 |

The nuScenes and Argoverse2 datasets exhibit geographical overlaps. StreamMapNet may propose a non-overlapping dataset split for them. The experimental results may be shown in Table 4. Note that the performance for nuScenes may degrade for all three methods. MapTracker may consistently outperform StreamMapNet with significant margins. The present framework 10 may surpass MapTracker, achieving improvements of +1.8 mAP, +1.2 C-mAP, and +0.9 mAP, +1.0 C-mAP on Argoverse2.

TABLE 4
Comparisons on non-overlapping datasets

| Dataset | Method | mAP↑ | C-mAP↑ |
|---|---|---|---|
| nuScenes | StreamMapNet [37] | 33.5 | 22.2 |
| | MapTracker [5] | 40.3 | 32.5 |
| | PredMapNet (Ours) | 42.1 | 33.7 |
| Argoverse2 | StreamMapNet [37] | 64.4 | 54.4 |
| | MapTracker [5] | 70.3 | 61.3 |
| | PredMapNet (Ours) | 71.2 | 62.3 |

An ablation study may be conducted to evaluate the contributions of the core ideas of the present framework 10. ResNet50 backbone may be used in these experiments. Training may be conducted on the nuScenes training dataset for 72 epochs. Evaluation may also be performed on the old split validation set.

Contributions of Main Components. Table 5 may demonstrate the impact of each component of the framework 10. Performance may be evaluated by adding each component one by one. The first row may represent a baseline model using MapTracker, which may achieve 74.7 mAP. Adding the semantic-aware query generator 14 may improve map consistency by providing context-aligned detection queries derived from BEV masks. With the semantic-aware query generator 14, a +0.3 gain in mAP may be observed and notable improvement in AP_{divider} (72.4→73.1). This may confirm the benefit of replacing randomly initialized queries with segmentation-guided semantic queries. Integrating the HMG module 20 may yield a further +0.4 mAP boost. By leveraging temporally aligned historical maps, HMG module 20 may refine track queries with fine-grained spatial priors, especially enhancing boundary and divider continuity. Furthermore, after incorporating STFG module 22, mAP may rise to 76.3. The STFG module 22 may explicitly forecast short-term motion and fuse it with current track queries, providing strong temporal priors. The +0.9 mAP improvement may validate that future reasoning complements history-based priors and may reduce implausible predictions. Lastly, applying an auxiliary depth supervision may help the backbone better encode 3D geometry, resulting in a higher performance of 76.9 mAP. This may confirm that improving the 3D spatial understanding may further benefit vectorized map construction.

TABLE 5
Ablation study of main components of PredMapNet

| | AP_{ped} | AP_{divider} | AP_{boundary} | mAP↑ |
|---|---|---|---|---|
| Baseline | 77.3 | 72.4 | 74.2 | 74.7 |
| +Semantic-Aware Query 3.1 | 77.2 | 73.1 | 74.7 | 75.0 |
| +History-Map Guidance 3.3 | 77.6 | 73.6 | 75.0 | 75.4 |
| +Short-Term Future Guidance 3.4 | 78.1 | 74.7 | 76.1 | 76.3 |
| +Aux Depth Supervision | 79.0 | 75.2 | 76.5 | 76.9 |

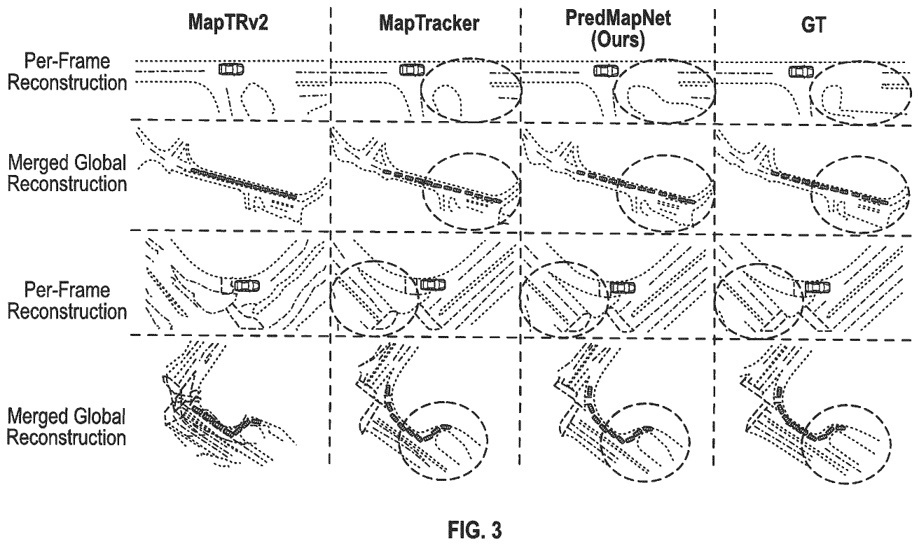

FIG. 3 may present a qualitative comparison between the present framework 10 and two state-of-the-art models, MapTRv2 and MapTracker, on challenging scenes from the nuScenes validation set. For better visualization, an integration function may be adopted to accumulate per-frame predictions into a single global HD vectorized map. Ground-truth (GT) annotations may be provided for reference. Across these sample scenes, the present framework 10 may exhibit stronger perceptual consistency and temporal alignment, especially in complex road geometries. The highlighted circle regions show key improvements: 1) the present framework 10 may more accurately capture the road boundaries and complete divider with improved geometric continuity. 2) The framework 10 may produce smoother lane boundaries across a long-range stretch, where Map Tracker introduces discontinuities and MapTRv2 yields noisy overlaps. These results may validate the effectiveness of the proposed sub-modules in producing high-quality vectorized maps that are both spatially precise and temporally stable.

An end-to-end framework 10 is presented above for consistent online vectorized HD map construction that may integrate both historical and future reasoning. To address potential issues in current query-based decoding pipelines, three modules may be proposed: a semantic-aware query generator 14 that may enhance detection with global semantic cues, an HMG module 20 that may leverage fine-grained instance-level history map for spatial refinement, and a STFG module 22 that may explicitly forecast map instance trajectories to improve temporal continuity. By combining historical information with predictive guidance, the present framework 10 may enable accurate and stable map instance localization and tracking across frames. Extensive experiments on nuScenes and Argoverse2 benchmarks may demonstrate that the present framework 10 may consistently outperform existing state-of-the-art approaches in both vectorized and rasterized map evaluation metrics, while maintaining practical inference efficiency. The results may validate the effectiveness of temporal priors in online mapping and provide a robust foundation for future research in dynamic scene understanding and global map construction for autonomous driving systems.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. An end-to-end tracking and prediction system for high definition (HD) vectorized map construction comprising:
a bird's-eye-view (BEV) encoder processing multi-view images at each frame extracting perception features from the multi-view images;
a semantic-aware query generator producing semantic-aware queries from the perception features and generating a rasterized map through multi-layer decoding; and
a map decoder processing the perception features and the semantic-aware queries together to produce mapping elements.

2. The system of claim 1, comprising a map storage storing previous predicted rasterized maps for each tracked instance.

3. The system of claim 1, comprising a map guidance device refining track queries using the previous predicted rasterized map stored in the map storage.

4. The system of claim 1, comprising a map guidance device sampling corresponding positions on the extract perception features from the map storage establishing a geometric prior for progressing track queries in a new frame and progressing propagation of track queries across temporal sequences.

5. The system of claim 1, comprising a short-term future guidance device predicting future polylines from historical trajectories and fusing the future polylines into track queries to guide query initialization in a next frame.

6. The system of claim 1, comprising a filtering device coupled to an output of the map decoder filtering output detected queries of the map decoder using a detection threshold.

7. The system of claim 1, wherein the perception features extracted from the multi-view images are perspective-view (PV) features and BEV features.

8. The system of claim 1, wherein the map decoder processes the perception features and the semantic-aware queries together to produce coordinates, categories of roadway markings and elements, and confidence scores.

9. An end-to-end tracking and prediction system for HD vectorized map construction comprising:
a BEV encoder processing multi-view images at each frame to extract perspective-view features and BEV features;
a semantic-aware query generator extracting semantic-aware queries from the BEV features using mask-aware attention and generating a rasterized map with BEV segmentation mask through multi-layer decoding;
a map decoder processing the perspective-view features and BEV features and the semantic-aware queries together to produce coordinates, roadway markings, and certainty scores; and
a filtering device filtering output detected queries of the map decoder as positive using a detection threshold based on the certainty scores.

10. The system of claim 9, wherein the filtering device initializes propagated track queries with corresponding detect queries tracked in a previous frame and filters using a tracking threshold, wherein positive output detected queries based on the certainty scores are propagated to a next frame as new track queries.

11. The system of claim 9, comprising a map memory coupled to an output of the filtering device storing a predicted rasterized map for each tracked instance.

12. The system of claim 11, comprising a map guidance module sampling corresponding positions on the extract perspective-view features and BEV features from the map memory establishing a geometric prior for progressing track queries in a new frame and progressing propagation of track queries across temporal sequences.

13. The system of claim 12, wherein the map guidance module applies padding to normalize feature lengths and applies a padding mask so each track query focuses on its corresponding positions during feature aggregation, wherein sampled instance-level features are fused into corresponding track queries via cross-attention.

14. The system of claim 9, comprising a future guidance module receiving the positive output detected queries as inputs and predicting short-term future positions of each query.

15. The system of claim 14, wherein the predicted short-term future positions of each query serve as focal points of future indicators for the map decoder.

16. The system of claim 9, wherein the semantic-aware queries are initialized and processed through a predetermined number of layers of a transformer decoder, at each layer the semantic-aware queries interact with the BEV features and guided by the BEV segmentation mask produced in a directly preceding layer.

17. The system of claim 9, wherein the semantic-aware queries are initialized and processed through a predetermined number of layers of a transformer decoder, at each layer the semantic-aware queries interact with the BEV features and guided by the BEV segmentation mask produced in a directly preceding layer, instant level BEV segmentation masks are obtained by applying a dot product between the BEV features and semantic-aware queries along a channel axis, the BEV segmentation masks used to update an instance level predicted rasterized map are stored in memory.

18. A method of forming an end-to-end tracking and prediction system for HD vectorized map construction comprising:
processing multi-view images at each frame to extract perspective-view features and BEV features;
extracting semantic-aware queries from the BEV features using mask-aware attention and generating a rasterized map with BEV segmentation mask through multi-layer decoding;
processing the perspective-view features and BEV features and the semantic-aware queries together to produce coordinates, roadway markings, and certainty scores through a map decoder;
filtering output detected queries of the map decoder as positive using a detection threshold based on the certainty scores;
storing a predicted rasterized map for each tracked instance in a map memory;
sampling corresponding positions on the extract perspective-view features and BEV features from the map memory establishing a geometric prior for progressing track queries in a new frame and progressing propagation of track queries across temporal sequences.

19. The method of claim 18, comprising receiving the positive output detected queries as inputs and predicting short-term future positions of each query.

20. The method of claim 19, wherein using the predicted short-term future positions of each query as focal points of future indicators for the map decoder.
